(19) United States
(12) Patent Application Publication
(10) Pub. No.: US 2011/0073533 A1
(43) Pub. Date: Mar. 31, 2011

(54) Rockngoldbasket

(76) Inventor: Ronald Richard Preston, Eagle, CO (US)

(21) Appl. No.: 12/586,909

(22) Filed: Sep. 30, 2009

(51) Int. Cl. B07C 5/00

(52) U.S. Cl. 209/606; 209/509

(57) ABSTRACT

A self contained and portable gold and gem separation kit. The apparatus is driven with a manual rocking motion to wash material with the self contained water. Using the natural wave motion, generated in the water from the rocking apparatus, the material is washed and classified. The bottom collection tray catches the classified material, and is removable for ease of collection of the concentrated material.

### BACKGROUND OF THE INVENTION

1. Field of the Invention

The present invention relates to the field of hydraulic classifiers specifically designed for recreational gold and gem miners and small mine operators. The present invention is particularly adapted for portable mobility in order to be carried out either immediately by a stream or removal there from to any location.

2. Description of Background Art

The use of gold recovery devices has a long history in the United States. From the simple gold pan, U.S. Pat. No. 3,855,119 to Stephenson discloses a gold pan, to a portable sluice box, U.S. Pat. No. 4,592,833. Perdue discloses a portable sluice box to more complicated implements such as a rocker box, U.S. Pat. No. 5,927,509 Lord discloses a gold separation kit. All of these devices are designed to remove gold from gold-bearing gravels.

Although the art is well developed, the ability to utilize an apparatus in different conditions is limited. A sluice box becomes unusable in desert conditions as does a dry washer become unusable in wet conditions.

Accordingly, the need exists to provide an apparatus which possesses portable mobility allowing it to be transported with relative ease to a variety of regions without sacrificing separation efficiency. The present invention responds to such needs.

### BRIEF SUMMARY OF THE INVENTION

The present invention is comprised of a self contained and portable gold and gem separation kit. It can be easily transported to any location for use either at a stream bed, high bank areas, beaches, deserts or elsewhere. The operational elements of the kit area stored within a box with handles for easy transport. To put the devise into operation, simply add water to the box, place the basket on the pivot brackets on the inside sides of the box, add gold or gem bearing gravel material to the classifier area and rock the basket back and forth. The rocking motion causes the water to enter the basket from the ends and wash the gravel material freeing the gold and gems from the gravel and allowing it to settle to the bottom of the basket. To retrieve gold or gems just remove lower pan and process the trapped material.

### BRIEF DESCRIPTION OF THE DRAWINGS

FIG. 1. Is an exploded isometric view illustrating the various elements that comprise the invention and their relationship to each other.

FIG. 2. Is a plan view of the material basket of FIG. 1.

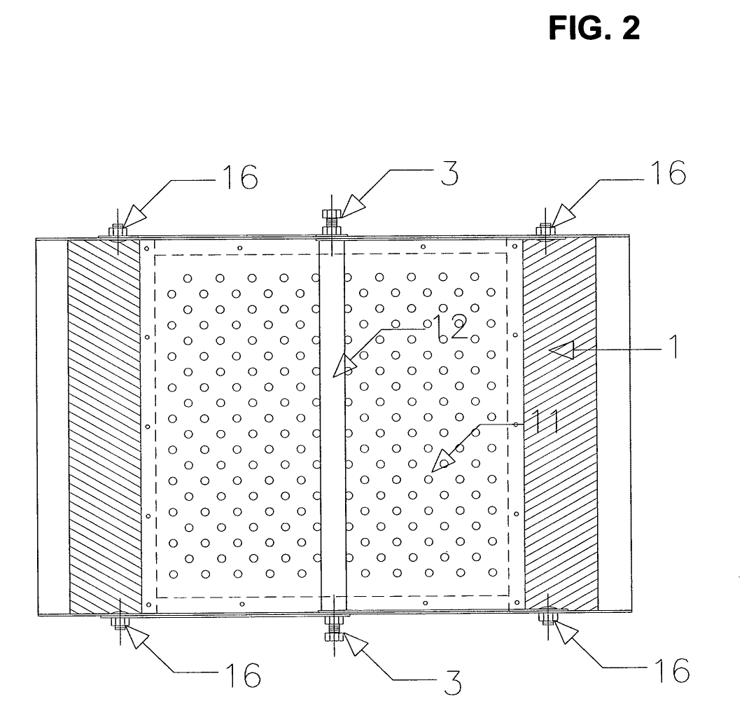

FIG. 3. Is a side view of the material basket of FIG. 1 and FIG. 2.

FIG. 4. Is an end view of the material basket of FIGS. 1, 2 and 3.

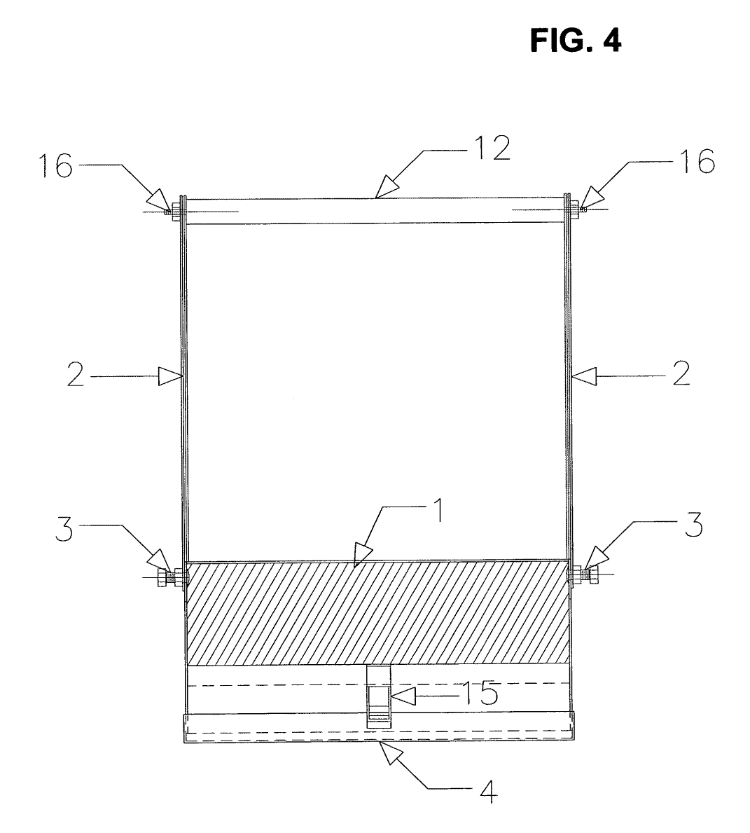

FIG. 5. Is a longitudinal cross sectional view of the invention of FIG. 1.

FIG. 6. Is a cross sectional view of the invention of FIG. 1.

### DETAILED DESCRIPTION OF THE DRAWINGS

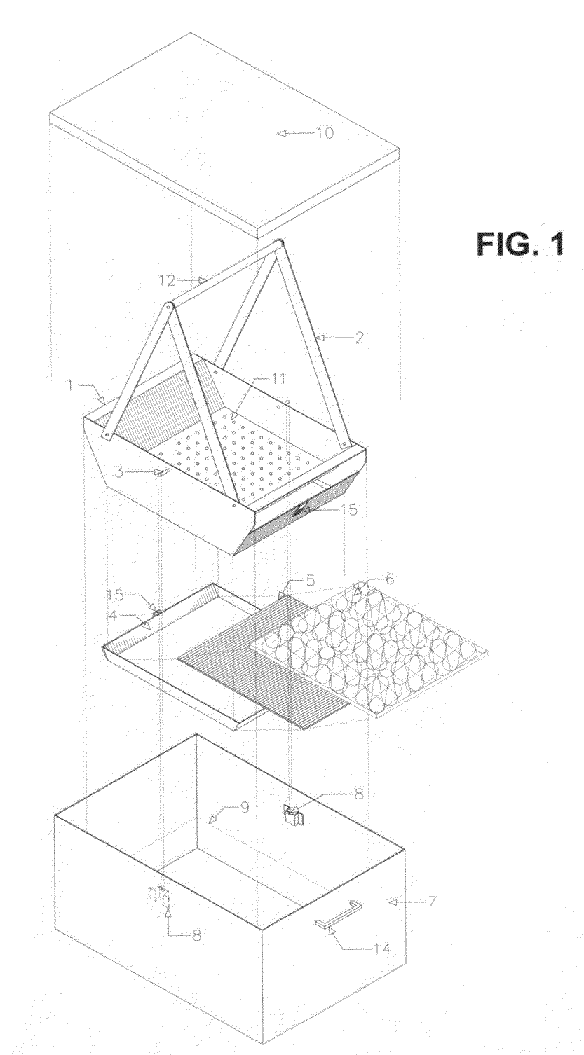

FIG. 1 is an exploded isometric view showing the present inventions three major components. The major components are the material basket 1, the bottom collection tray 4 and the carrying box 7 with lid 10.

The basket is comprised of the main basket 1, a perforated sheet metal classifier 11, a wood handle 12 with collapsible supports 2, rocking pivots 3 on each side, and lathes 15 at each end. The bottom collection tray 4 is comprised of the base tray 4 with latches at each end 15, removable ribbed rubber mat 5 and removable woven vinyl matting 6.

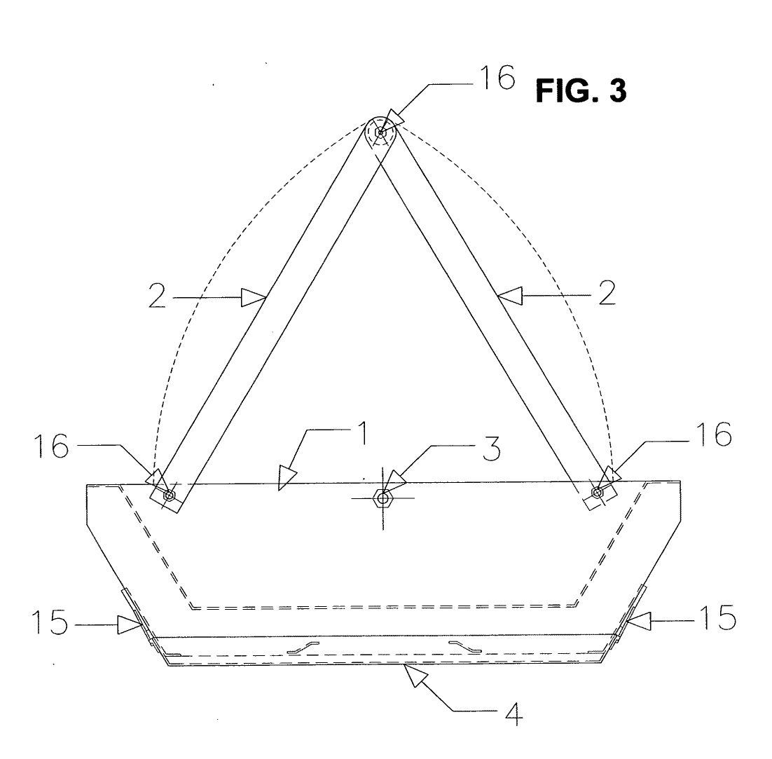

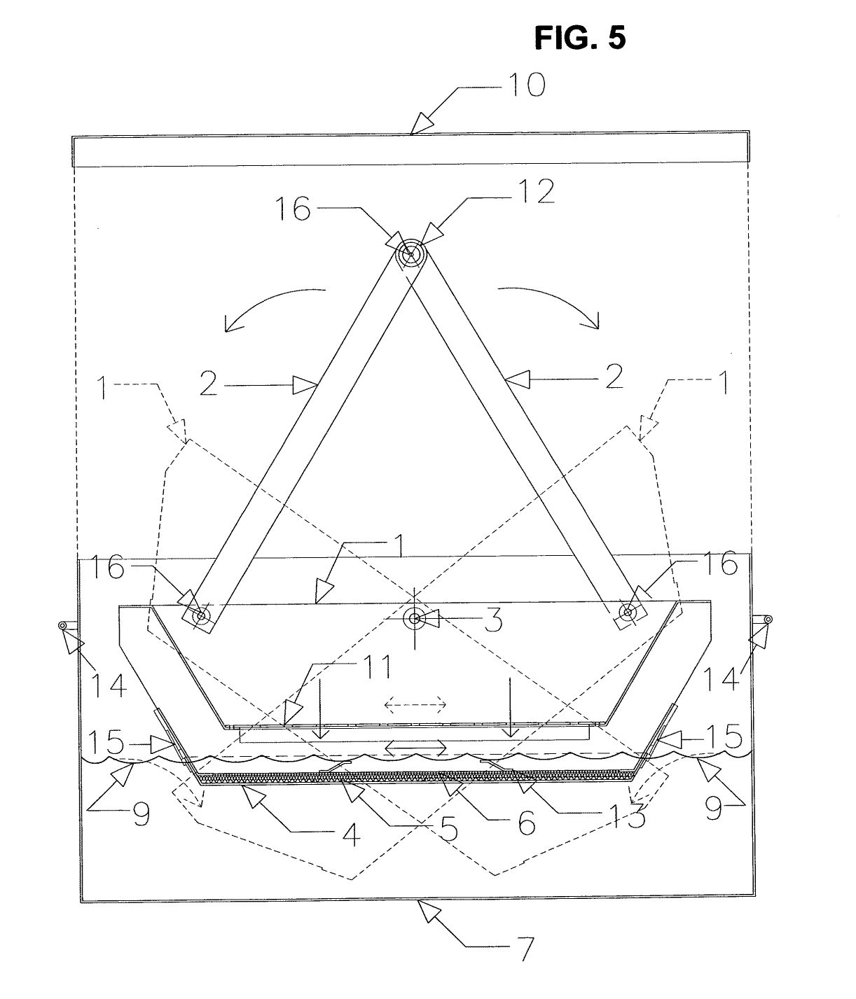

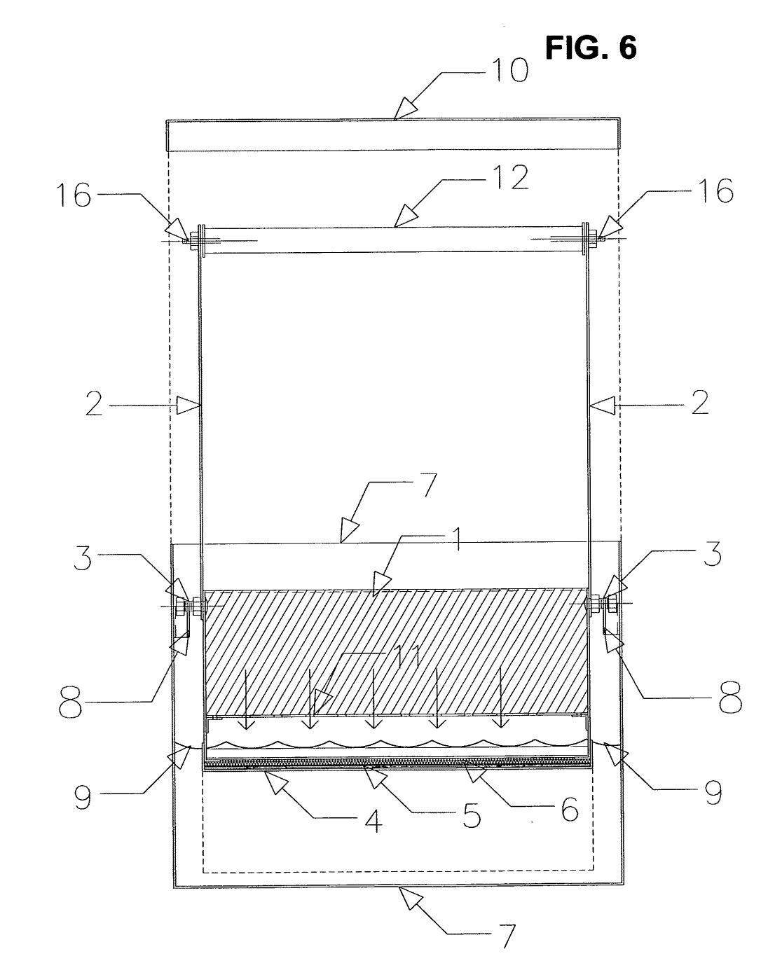

The carrying box is comprised of the main carrying box 7 with handles 14 at each end, interior mounted pivoting brackets 8 on each side, the water 9 and a removable reattachable lid 10. In practice, the lid 10 is removed from the carrying box 7 and the rest of the elements are removed. The box 7 is then partially filled with water 9. The collapsible handle 12 on the material basket 1 is raised into position and the supports 2 are secured to handle 12 with fasteners 16 as shown in FIG. 3. The material basket 1 is then placed into the carrying box 7 using the mounting brackets 8 to support the rocking pivots 3 on each side of the material basket 1. At this point, the Rock n Gold Basket is ready for operation. Placing gold or gem bearing gravel material into the material basket 1 on top of the perforated sheet metal classifier 11. The basket 1 is manually put into a rocking motion back and forth as illustrated in FIGS. 5 and 6 by the arrows. As the basket 1 is dipped down, the water 9 enters the basket 1 at the ends. As the basket 1 is rocked back and forth, the waters natural wave motion washes the gravel. Gravity pulls the water and fine particulates down through the classifier 11 into the lower area of the basket 1. The classifier 11 catches the larger material while the fine particles are then washed down and back and forth across the woven vinyl matting 6 (miners moss). The riffles 13 act to hold down the miners moss 6 and add additional agitation to the water helping separate the material. The heavier materials continue down into and through the miners moss 6 trapping the larger material and allowing the finer particles to reach the ribbed rubber matting 5 within the collection tray 4.

The lighter material is washed out of the ends of the basket 1 and settles into the bottom of the carrying box 7. At this point, the basket 1 can be removed from the carrying box 7. The bottom collection try 4 can be removed from the basket 1 by releasing the latches 15 on each end. The larger washed gravel material then remains on top of the classifier 11 and can easily be visually inspected for larger gold nuggets and gems then the larger gravel materials can be discarded. The finer gravel material captured by the collection tray 4, the miners moss 6 and the ribbed rubber matting 5 can be stored in a separate container for future cleaning and separation. The gold and gems will be contained within this material. The carrying box 7 can then be cleaned out of excess material and the procedure can be repeated. When finished, the carrying box 7 can be emptied of water, the handle 12 on the basket 1 can be collapsed back into a storage position, the basket 1 can be replaced back into the carrying box 7 and the lid 10 can be reattached for transport.

Although only an exemplary embodiment of the invention has been described in detail above, those skilled in the art will readily appreciate that many modifications are possible without materially departing from the novel teachings and advantages of this invention. Accordingly, all such modifications are intended within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the present invention.

1. A gold and gem separation kit comprising:
A carrying box having an open top area, a removable reattachable lid sized to enclose said open top area, interior mounted pivoting brackets, and two exterior mounted handles for ease of carrying;
A material basket removable within said carrying box.

2. The gold and gem separation kit of claim 1 wherein said material basket comprises:
Collapsible handle, perforated sheet metal classifier, and bottom removable reattachable collection tray.

3. The gold and gem separation kit of claim 2 wherein said collection tray comprises:
Metal base tray with latches, removable ribbed rubber matting, and removable woven vinyl matting.
